(19) United States
(12) Patent Application Publication
(10) Pub. No.: US 2009/0186152 A1
(43) Pub. Date: Jul. 23, 2009

(54) Light Guide Plate and Manufacturing Method thereof

(76) Inventors: Tzeng-Ke Shiau, Hsin-Chu (TW); Ping-Feng Hwang, Hsin-Chu (TW); Wen-Bin Chou, Hsin-Chu (TW)

Correspondence Address: HDLS Patent & Trademark Services, P.O. BOX 220746, CHANTILLY, VA, 20153-0746, US

(21) Appl. No.: 12/197,259

(22) Filed: Aug. 24, 2008

(30) Foreign Application Priority Data
Jan. 17, 2008 (TW) 097101735

(51) Int. Cl. G02B 6/04

(52) U.S. Cl. 427/163.2

(57) ABSTRACT

A manufacturing method of light guide plate (LGP) for manufacturing a LGP has a plurality of colloid dot like micro-optical structures on its surface. The method includes the following processes. First, a substrate with an embossing structure is provided. Then, a plurality of colloid dots are formed on a surface of the substrate by jetting. Afterwards, a drying process is performed to convert the colloid dots into the colloid dots like micro-optical structures. Finally, a LGP is manufactured by the manufacturing method.

### BACKGROUND

The present invention relates to an optical plate, especially to a light guide plate (LGP), a manufacturing method thereof and a backlight module using the LGP.

Usually, a liquid crystal display (LCD) panel does not emit light itself. A backlight module is used to provide a display light source to the LCD panel. The backlight module mainly includes a light source, an LGP and optical films. The LGP is used to convert the rays emitted from the light sources (e.g. point light source or linear light source) into area light sources.

A surface structure of the LGP or the optical films of the backlight module is usually produced by a molding process (such as rolling, extraction and extrusion, heat pressing, injection and other processes). In the molding process, the surface structure of the LGP or the optical films of the backlight module may be manufactured by a mold which has a corresponding surface structure. In addition, a method of forming micro structures on surfaces of the above optical elements (i.e. the LGP and the optical films) includes a printing method and a non-printing method (e.g., electroforming, injection) and so on.

Conventionally, the manufacturing methods of the LGP, the optical films and other optical elements employ different processes. The different processes are complicated and may not support to each other. When different micro-optical structures are needed to be manufactured, different manufacturing processes may be provided to perform the manufacturing of their corresponding micro-optical structures. Therefore, the flexibility of the manufacturing is poor. Referring to FIG. 1, take a present molding process for example. First, a design value (i.e. predetermined form of the product) (S1) is set up. Second, a stamper prototype is manufactured according to the design value (S2). Third, a design prototype (i.e. prototype product) is manufactured by the stamper prototype (S3). If the design is needed to be changed, for example, to add other optical structures onto the LGP surface with an embossing structure thereon, the above steps (S1 to S3) need to be repeated. Afterwards, a mold for mass production is manufactured (S4), and then products are manufactured by the mold (S5).

A published US patent number US20060291065 discloses a method of forming micro lenses on a surface of a light diffusing plate or an optical sheet by ink jetting. The micro lenses are aligned in a single mode (i.e. the sizes of the micro lenses are the same, and the micro lenses are aligned in an invariable form). The shape and the size of the micro lenses are controlled by an effect of the gravity and a position angle of the optical sheet.

An issued Taiwan patent number TWI253769 discloses a technique of coating fluorescent powder on a surface of the LGP by ink jetting. The fluorescent powder is a wavelength conversion material. Further, the issued Taiwan patent number TWI253769 relates to a manner in coating the fluorescent powder on the surface of the LGP equally, and without relating to form a special pattern on the surface of the LGP, such as a pattern with different size or different position.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF SUMMARY

The present invention relates to a manufacturing method of light guide plate for improving production efficiency.

The present invention also relates to a light guide plate which has a lower manufacturing cost.

To achieve one of or all of the objectives above, a manufacture method of light guide plate includes the following steps is provided. First, a substrate with an embossing structure is provided. Then, a plurality of colloid dots with different sizes are formed on a surface of the substrate by jetting. Afterward, the colloid dots are solidified to convert the colloid dots into a plurality of dot like micro-optical structures.

The present invention also provides a light guide plate manufactured by the above manufacturing method.

The present manufacturing method of light guide plate is a manufacturing method with changeable flexibility. In other words, when a design prototype of a light guide plate needs to be amended, there is no need to manufacture a new stamper prototype, but to make or modify the design prototype directly, and directly manufacture a mold for mass production using other processes such as electrotyping according to the modified design prototype. Therefore, the manufacturing method of light guide plate of the present invention may improve the production efficiency, and reduce the production cost.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a manufacturing flow chart of a conventional light guide plate;

FIG. 2A to FIG. 2C are flow charts of a manufacturing method of light guide plate of an embodiment of the present invention;

FIG. 3 is a schematic view of forming colloid dots on a surface of a substrate in another embodiment of the present invention;

FIG. 4 is a schematic view of an ink jetting device of an embodiment of the present invention; and

FIG. 5 is a manufacturing flow chart when a light guide plate needs to be amended in an embodiment of the present invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

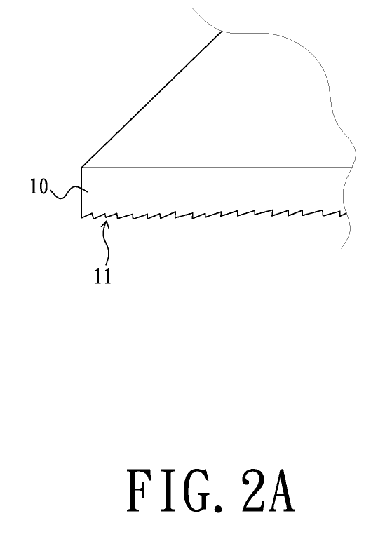

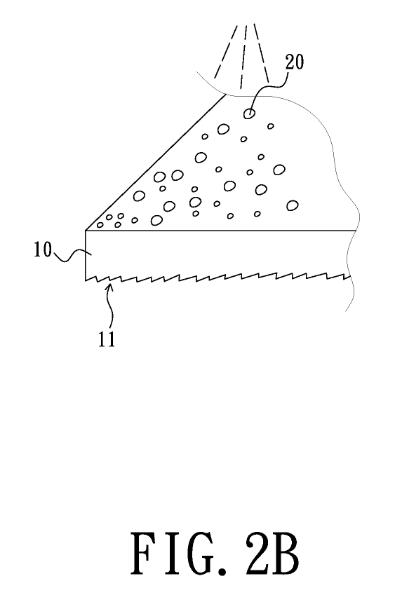

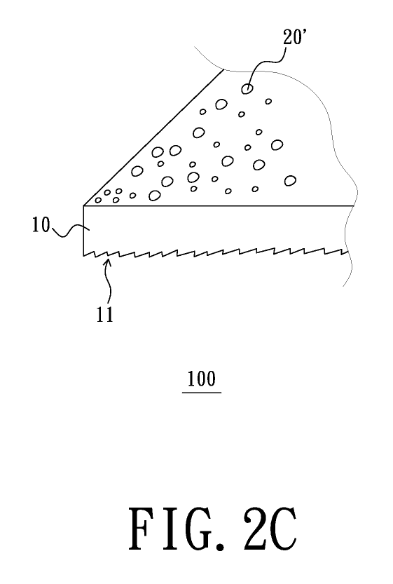

FIG. 2A to FIG. 2C are flow charts of a manufacturing method of light guide plate (LGP) of an exemplary embodiment of the present invention. Referring to FIG. 2A to 2C, the manufacturing method includes the following steps.

First, referring to FIG. 2A, a substrate 10 with an embossing structure 11 is provided. In this embodiment of the present invention, the embossing structure 11 is a structure with a plurality of V-cut grooves.

Then, referring also to FIG. 2B, a plurality of colloid dots 20 are formed on a surface of the substrate 10 by jetting. The colloid dots 20 are formed on the surface of the substrate 10 according to a predetermined jetting position and a number of predetermined jetting times.

Afterward, referring to FIG. 2C, the colloid dots 20 are solidified to convert the colloid dots 20 into a plurality of predetermined dots like micro-optical structures 20′. In other words, the LGP 100 manufactured by the manufacturing method of the present embodiment includes the substrate 10 with the embossing structure 11, and dot like micro-optical structures 20′ disposed on the surface of the substrate 10. In addition, the colloid dots 20 are solidified by a drying treatment process.

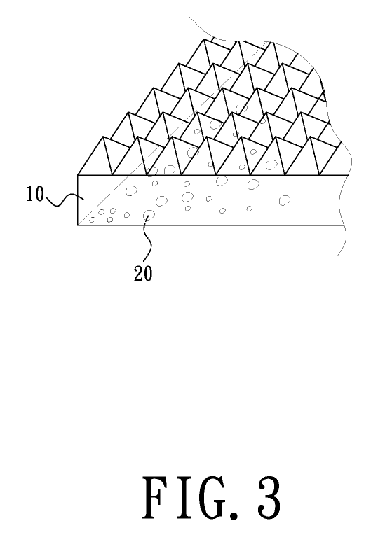

Alternatively, the embossing structure 11 may be formed in other configuration. For example, the embossing structure 11 may be a structure with a plurality of pyramids (as shown in FIG. 3), a structure with a plurality of cylindrical mirrors or a plurality of cones.

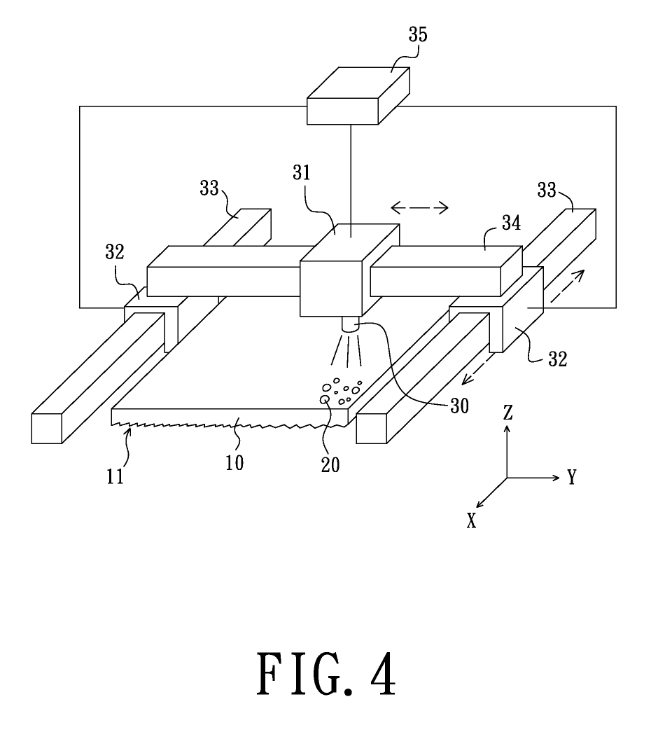

In addition, an implement for jetting in the embodiment of the present invention is shown in FIG. 4. The implement for jetting is an ink jetting device which includes an ink jet head 30, an ink cartridge 31 with colloid optical materials stored therein and a driving mechanism. The driving mechanism includes a driving unit 35 and two sliders 32. The driving unit 35 is electrically connected to the ink cartridge 31 and the sliders 32 for driving the sliders 32 slide along a first slide pole 33 (i.e. slide along an X-axis) and driving the ink cartridge 31 slide along a second slide pole 34 (i.e. slide along a Y-axis).

The ink jetting device may randomly jet the colloid optical materials (such as ultraviolet curing adhesives) on either surface of the substrate 10 (may be a single surface or more than two surfaces). In addition, the colloid dots 20 with different sizes which are predeterminedly designed may be formed on the surface of the substrate 10 by controlling a number of jetting times. As a result, a prototype or a product may be directly manufactured. The colloid dots 20 are distributed in random distribution, and the diameter of each colloid dot 20 is different from another.

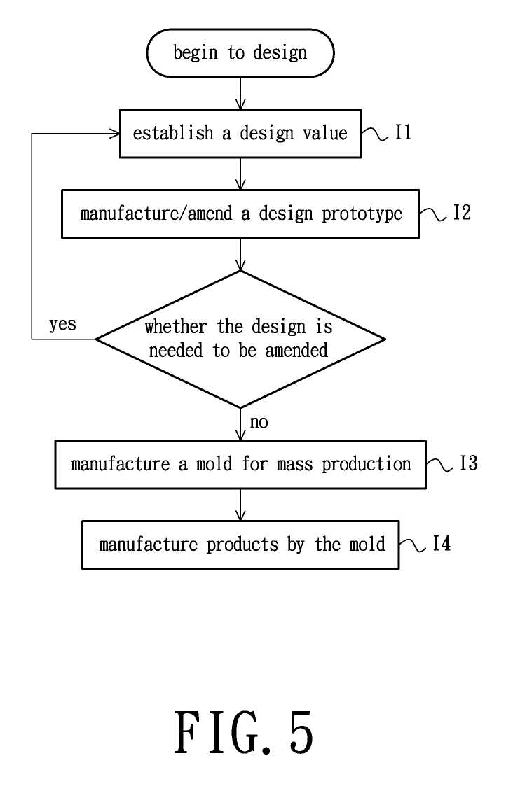

FIG. 5 is a manufacturing flow chart when a light guide plate needs to be changed in an embodiment of the present invention. Referring to FIG. 5, first, a design value (predetermined prototype) based on a factual specification or a function of the product is established (I1), and then a design prototype (prototype product) based on the design value is manufactured (I2). The design prototype is a substrate 10 with an embossing structure 11. If the design needs to be changed, for example, adding other optical structures (such as micro lens or matte structures) on a surface of the substrate 10 with the embossing structure 11, the design only needs to be established a new design value based on a new factual specification or a new function of the product (I1). And then, the colloid optical materials are jetted on a surface of the substrate 10 to form colloid dots 20 (i.e. optical structures) with different sizes. Therefore, there is no need to manufacture a new stamper prototype, but to modify the design prototype (I2) directly.

Afterward, a mold for mass production is manufactured directly using other processes such as electrotyping according to the modified design prototype.

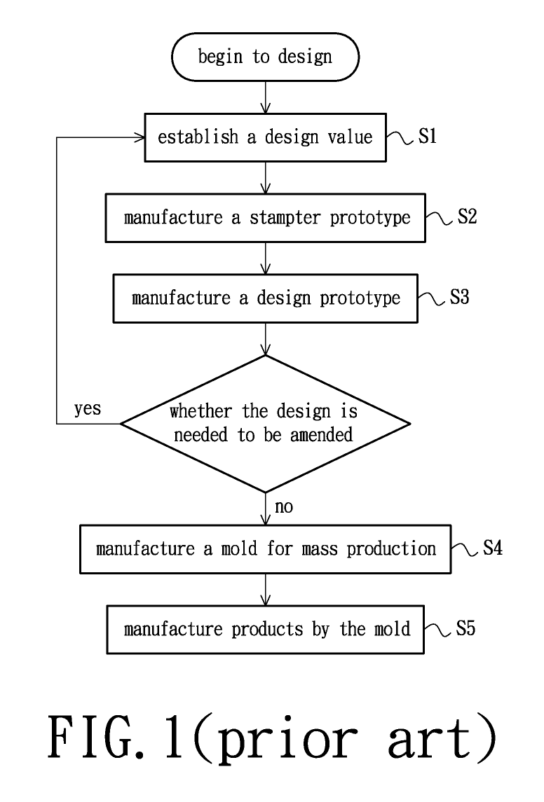

Compare the FIG. 1 with FIG. 5, by jetting, other optical structures (such as micro lens or matte structures) may be directly added to the substrate 10 with embossing structure 11. When a design of the LGP 100 needs to be changed, there is no need to manufacture a new stamper prototype (in other words, the step S2 in FIG. 1 is omitted). Therefore, the time for modifying the design is reduced, so that the whole time of the process is reduced. In other words, the manufacturing method of LGP in the embodiment of the present invention may improve the production efficiency of the LGP 100, so as to reduce the production cost thereof.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A manufacturing method of a light guide plate, comprising:
providing a substrate with an embossing structure;
forming a plurality of colloid dots with different sizes on a surface of the substrate by jetting; and
solidifying the colloid dots to the surface of the substrate and converting the colloid dots into a plurality of dot like micro-optical structures.

2. The manufacturing method of light guide plate as claimed in claim 1, wherein the step of solidifying the colloid dots is performed by a drying treatment process.

3. The manufacturing method of light guide plate as claimed in claim 1, wherein the embossing structure is a structure with a plurality of V-cut grooves.

4. The manufacturing method of light guide plate as claimed in claim 1, wherein the embossing structure is a structure with a plurality of cylindrical mirrors.

5. The manufacturing method of light guide plate as claimed in claim 1, wherein the embossing structure is a structure with a plurality of pyramids.

6. The manufacturing method of light guide plate as claimed in claim 1, wherein the embossing structure is a structure with a plurality of cones.

7. The manufacturing method of light guide plate as claimed in claim 1, wherein the step of jetting is performed by an ink spraying process.

8. The manufacturing method of light guide plate as claimed in claim 1, wherein the colloid dots are distributed on the substrate in a random distribution, and a diameter of each colloid dot is different from the others.

9. The manufacturing method of light guide plate as claimed in claim 1, wherein the colloid dots are formed on the surface of the substrate according to a predetermined jetting position and a number of predetermined jetting times.

10. A light guide plate manufactured by the manufacturing method of light guide plate claimed in claim 1.
